(19) United States
(12) Patent Application Publication
(10) Pub. No.: US 2005/0237244 A1
(43) Pub. Date: Oct. 27, 2005

(54) Compact RF antenna

(76) Inventors: Ayoub Annabi, Tavaux (FR); Daniel Leclerc, Crissey (FR); Frederic Diximus, Dole (FR)

Correspondence Address: BLANK ROME LLP, 600 NEW HAMPSHIRE AVENUE, N.W., WASHINGTON, DC, 20037, US

(21) Appl. No.: 11/108,763

(22) Filed: Apr. 19, 2005

(30) Foreign Application Priority Data
Apr. 23, 2004 (FR) 04 04311

(51) Int. Cl. H01Q 1/24

(52) U.S. Cl. 343/702; 343/895; 343/846

(57) ABSTRACT

A monopole type antenna suitable for operating in cellular frequency bands, the antenna comprising: a conductive surface forming a radiating element and including an electrical connection zone; a compact conductive counterpoise including a connection zone; and a feed line comprising an antenna cable connected to the connection zones of said radiating element and of said compact counterpoise. In the antenna, said radiating element is in the form of an open loop having two branches both connected to the antenna cable and defining first and second radiating portions, each of the radiating portions is suitable for entering into resonance at at least one cellular frequency and extends in a main direction; and these two main directions are substantially parallel so as to operate parasitically and with coupling between the two radiating portions.

### FIELD OF THE INVENTION

The present invention relates to a compact antenna of the monopole type for transmitting and receiving signals, and suitable for use particularly, but not exclusively, in a portable terminal operating on different frequency bands.

More precisely, the invention relates to a compact antenna of the monopole type comprising:
a conductive surface forming a radiating element and including an electrical connection zone;
a compact conductive counterpoise including a connection zone; and
a feed line comprising an antenna cable connected to the connection zones of said radiating element and of said compact counterpoise.

### BACKGROUND OF THE INVENTION

At present, the specifications of an antenna must satisfy at least two requirements: firstly the antenna must be capable of operating at the different frequency bands of the available types of network; and secondly the dimensions of the antenna must be adapted to the ever-smaller dimensions of terminals.

Within the bounds of possibility, it is clear that these requirements must be satisfied without detriment to cost or to the performance of the antenna.

Portable terminal antennas are already known that are in the form of printed circuits.

Nevertheless, most such antennas are not only of dimensions that are too great, but their ground planes are also dependent on the ground plane of a portable terminal, and the antennas present passbands that are too narrow.

### OBJECTS AND SUMMARY OF THE INVENTION

An object of the present invention is to provide a compact antenna suitable for use in a portable terminal, which antenna presents very small volume and can be used in distinct cellular frequency bands.

This object is achieved by the facts that the radiating element is in the form of an open loop having two branches both connected to the antenna cable and defining first and second radiating portions, that each of the radiating portions is suitable for entering into resonance at at least one cellular frequency and extends in a main direction; and that these two main directions are substantially parallel so as to operate parasitically and with coupling between the two radiating portions.

Generally, the radiating portions and the counterpoise are present in the form of metal plates secured on a dielectric support. Nevertheless it is possible to implement the antenna by metal coating a dielectric substrate that is rigid or flexible.

The compact antenna preferably extends longitudinally, and the main directions of the radiating portions are parallel to the longitudinal direction of the compact antenna.

Preferably, the compact antenna is designed to operate at the main frequencies for cellular telephony, in particular at the following frequencies: GSM 850/900; DCS 1800; PCS 1900; and UMTS 2100.

It will be understood that the two radiating portions are disposed close to each other so that coupling or parasitic phenomena can appear, specifically in order to broaden the passband of the antenna.

Preferably, the open loop is in the form of an element that forms an almost-closed loop, with an opening presenting a length that is very small compared to the total length of the element.

Preferably, the loop presents only one opening, but it would also be quite possible to make a plurality of openings in the loop.

Still preferably, but not necessarily, the counterpoise and the conductive surface present a single connection zone.

Advantageously, the first radiating portion is a conductive surface that is substantially plane, having a portion constituted by a juxtaposition of identical patterns extending in a direction that is substantially orthogonal to the main direction of the first radiating portion.

Preferably, said pattern is substantially in the form of a V-shape such that the first radiating portion is in the form of a zigzag extending in the main direction.

Preferably, said portion includes at least four identical patterns.

Advantageously, the folded-out length of the first radiating portion is substantially proportional to one-fourth of the wavelength of the wave whose center frequency is substantially equal to the lowest cellular frequency.

Preferably, the lowest center frequency is a GSM frequency substantially equal to 900 megahertz (MHz).

Clearly, the folded-out length of the first radiating portion corresponds substantially to the length that the first radiating portion would have if it were rectilinear.

Preferably, the folded-out length of the first radiating portion corresponds substantially to the folded-out length of one pattern multiplied by the number of patterns making up the first radiating portion.

Advantageously, the second radiating portion is a conductor that is substantially rectilinear, extending in the main direction of said second radiating portion.

Preferably, the second radiating portion is substantially rectangular in shape. Nevertheless, the second radiating portion could also be made up of a plurality of rectilinear elements extending in the main direction of the second radiating portion.

Preferably, the length of the second radiating portion is substantially proportional to one-fourth of the wavelength having a center frequency substantially equal to the highest cellular frequency.

Preferably, the highest cellular frequency is a UMTS frequency substantially equal to 2100 MHz.

It will be understood that the length of the radiating portion is substantially equal to the length of the rectilinear conductor.

Advantageously, the compact counterpoise has an axis of symmetry parallel to the main direction of the first radiating portion and includes at least one U-shaped portion having first and second limbs, with the first limb being connected to the connection zone of said compact counterpoise.

It will be understood that a U-shaped portion presents overall size that is much smaller than a rectilinear portion having the same folded-out length.

Advantageously, said at least one U-shaped conductive portion comprises two rectilinear limbs each extending in a direction substantially parallel to the axis of symmetry of the contact counterpoise.

Since this portion extends in the main direction of the first radiating portion, it will be understood that the length of the counterpoise seen in this main direction is practically half what it would be if said counterpoise portion were folded out.

As a result, the counterpoise is made more compact.

Advantageously, the compact counterpoise has two U-shaped portions with their second limbs placed facing each other.

Preferably, the two U-shaped portions are symmetrical about the axis of symmetry of the counterpoise, and the second limbs of the U-shaped portions are parallel and disposed close to each other.

Advantageously, the compact counterpoise further includes at least one rectilinear conductor portion extending in a direction parallel to the axis of symmetry of the compact counterpoise and an end zone of said rectilinear portion is connected to the connection zone of the compact counterpoise.

Preferably, said rectilinear conductor portion is parallel to the first and second limbs of a U-shaped portion.

Advantageously, the rectilinear portion extends substantially between the two limbs of a U-shaped portion.

It will be understood that this particular disposition serves not only to improve the overall compactness of the antenna, but also to improve the performance of the antenna.

The term “near” should be understood as meaning that the distance between the two portions is much less than the wavelength of the wave having the highest frequency.

Advantageously, the lengths of the limbs of a U-shaped portion and of a rectilinear portion are substantially equal.

It will thus be understood that the folded-out length of a U-shaped portion is substantially equal to twice the length of a rectilinear portion.

### BRIEF DESCRIPTION OF THE DRAWINGS

Other characteristics and advantages of the invention appear better on reading the following description of various embodiments of the invention given as non-limiting examples. The description refers to the accompanying figures, in which:

FIG. 1 shows the radiating element and the counterpoise in a first embodiment of the compact antenna;

FIG. 2 shows the radiating element and the counterpoise in a second embodiment of the compact antenna;

FIG. 3 is a perspective view partially in section showing the connection portions of the radiating portion and of the counterpoise;

FIG. 4 shows the distribution of currents over the compact antenna in its first embodiment when used at a GSM frequency of about 900 MHz;

FIG. 5 shows the distribution of currents over the compact antenna in its first embodiment when it is used at a PCS frequency of about 1900 MHz; and

FIG. 6 is a graph showing the gain of the antenna in dBi as a function of frequency in gigahertz.

### MORE DETAILED DESCRIPTION

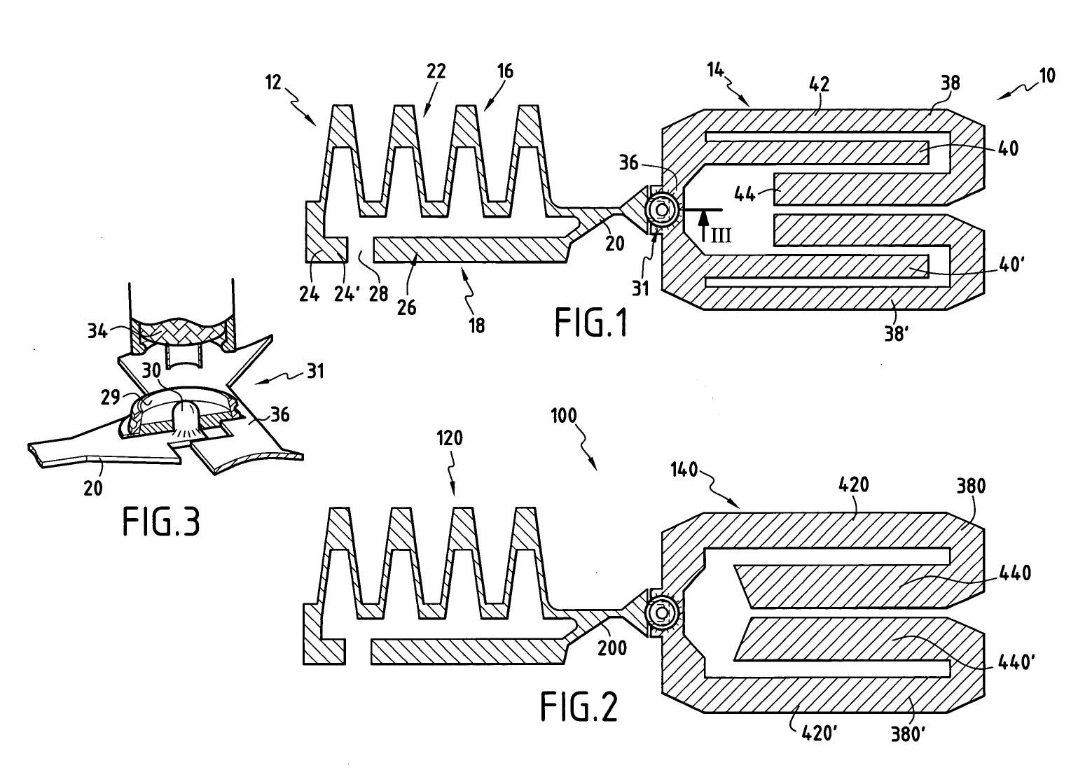

With reference to FIG. 1, there follows a description of a compact antenna 10 constituting a first embodiment.

The compact antenna 10 is preferably designed to operate at mobile telephony frequencies: GSM 850/900 MHz, DCS 1800 MHz; PCS 1900 MHz, and UMTS 2100 MHz.

To explain the operation of the antenna, a lowest cellular frequency is defined as is a highest cellular frequency.

The lowest cellular frequency is about 850 MHz and the highest cellular frequency is about 2100 MHz.

These two cell phone frequencies do not constitute the frequency operating limits of the compact antenna, but serve to describe the architecture and to explain the operation of the compact antenna. It is possible to use the compact antenna at a frequency higher than the highest cellular frequency, in particular at UMTS frequencies of the order of 2100 MHz.

The compact antenna 10 as shown comprises an electrical circuit printed on insulation (not shown). This insulation is commonly referred to as a “dielectric” and may be made out of FR4 epoxy glass, for example.

The compact antenna 10 has a first conductive surface forming a radiating element 12, and a second conductive surface forming a counterpoise 14, which can also be referred to as a ground plane.

The conductive surfaces are preferably substantially plane and made of copper.

As can be seen in FIG. 1, the compact antenna 10 extends mainly in a longitudinal direction.

The structure of the radiating element 12 is described in greater detail below.

As can be seen in FIG. 1, the radiating element presents substantially the form of an open loop made up of two conductive branches 16, 18 extending substantially along main directions that are parallel to the longitudinal direction of the compact antenna 10.

As can be seen in FIG. 1, the two branches are electrically interconnected at one of their ends via an electrical connection zone 20.

More precisely, this connection zone is referred to throughout the description below as the connection zone of the radiating element.

The first branch 16 of the radiating element 12 has a first portion 22 forming a zigzag, i.e. a juxtaposition of substantially V-shaped patterns connected together via the ends of the limbs of the V-shapes.

As can be seen in FIG. 1, the V-shaped patterns are oriented substantially in a direction that is orthogonal to the longitudinal direction of the radiating element.

The portion 22 forming a zigzag preferably has four V-shaped patterns with the end of the last V-shaped pattern remote from the connection zone being connected to an end portion 24 terminating the first branch 16.

This first branch 16 forms a first radiating portion that is preferably suitable for radiating at frequencies belonging to the GSM frequency band, i.e. frequencies lying in the range 850 MHz to 1000 MHz.

The zigzag-forming portion 22 is of a length that is substantially equal to one-fourth of the wavelength at the center frequency of the GSM band covering the range 850 MHz to 1000 MHz, i.e. preferably substantially equal to 900 MHz.

The second branch 18 of the radiating element 12 comprises a conductive portion 26 of substantially rectangular shape extending in the longitudinal direction of the compact antenna 10.

Preferably, the length of this rectangular portion 26 is substantially proportional to one-fourth of the wavelength at the highest center frequency between 1700 MHz to 2100 MHz, preferably equal to 1900 MHz.

In order to further improve the performance of the antenna, as explained in greater detail below, the folded-out length of the zigzag-forming portion 22 is preferably substantially equal to twice the length of the rectangular portion 26.

As mentioned above, and as can be seen in FIG. 1, the radiating element 12 forms an open loop. I.e. there is an opening 28 constituting a gap between the ends of the branches 16, 18 remote from their ends that are interconnected.

This opening 28 is preferably situated between the end portion 24 terminating the branch 22 and the end of the rectangular portion 26.

The end portion 24 is L-shaped, with at least one of its limbs 24′ being rectangular in shape with a width that is substantially equal to the width of the rectangular portion 26.

The folded-out length of the end portion 24 is preferably small compared with the folded-out length of the zigzag-forming portion 22.

It will thus be understood from FIG. 1 that said limb 24′ of rectangular shape is in line with the rectangular portion 26.

Preferably, the width of the opening 28, i.e. the distance between the ends of the two branches is substantially equal to the width of the rectangular portion 26. In any event, it is much less than one-tenth of the wavelength at the highest frequency.

Another remarkable characteristic, the advantage of which is explained in greater detail below, is that the rectangular portion 26 is relatively close to the ends of the limbs of the V-shaped patterns. More precisely, the distance between the rectangular portion 26 and the ends of the limbs of the V-shaped patterns is much less than one-tenth of the wavelength at the highest cellular frequency.

As can be seen in FIG. 3, the connection zone 20 of the radiating element 12 is preferably electrically connected to a central conductor 30 of a connector 31 suitable for being connected to a feed line 32.

The feed line is preferably a coaxial cable having an impedance of 50 ohms (Ω).

This feed line also has shielding 34 that is electrically connectable to a peripheral conductor 29 of the connector 31 which is electrically connected to a connection zone 36 of the counterpoise 14 and electrically insulated from the connection zone 20 of the radiating element 12.

Still with reference to FIG. 1, there follows a more detailed description of the structure of the counterpoise 14.

The counterpoise 14 has an axis of symmetry extending parallel to the longitudinal direction of the compact antenna 14.

More precisely, this axis of symmetry passes substantially through the center of the connection zone 36 of the counterpoise 14.

With reference to FIG. 1, it can be seen that the counterpoise 14 comprises two portions 38 and 38′ that are U-shaped, and two rectilinear portions 40 and 40′. The two U-shaped portions and the two rectilinear portions are symmetrical to one another, so the description below relates solely to the U-shaped portion 38 and solely to the rectilinear portion 40.

The U-shaped portion 38 has a first limb 42 with its end electrically connected to the connection zone 36 of the counterpoise 14, and a second limb 44.

The two limbs 42 and 44 of the U-shaped portion U are parallel to each other, each extending parallel to the longitudinal direction of the compact antenna.

The U-shaped portion is placed in such a manner that the second limb 44 is situated between the first limb 42 and the axis of symmetry of the counterpoise.

The rectilinear portion 40 of substantially rectangular shape is electrically connected to the connection zone 36 of the counterpoise 14 via one of its ends and it extends in a direction parallel to the longitudinal direction of the compact antenna 10.

The other end of the rectilinear portion extends between the two limbs 42, 44 of the U-shaped portion so that said limbs run adjacent to practically the full length of the sides of the rectilinear portion 40.

In addition, because of symmetry, it will be understood that the second limb 44 of the U-shaped portion 38 faces the corresponding limb of the symmetrical U-shaped portion 38′.

Preferably, the distance between these two limbs is much than one-twentieth of the wavelength at the highest cellular frequency, i.e. it is of millimeter order.

In addition, the folded-out length of the U-shaped portion 38 of the counterpoise 14 is preferably substantially equal to or slightly greater than the folded-out length of the zigzag-forming portion 22.

Similarly, the length of the rectilinear portion 40 of the counterpoise 14 is preferably substantially equal to or slightly greater than the length of the rectangular portion 26 of the radiating element 12.

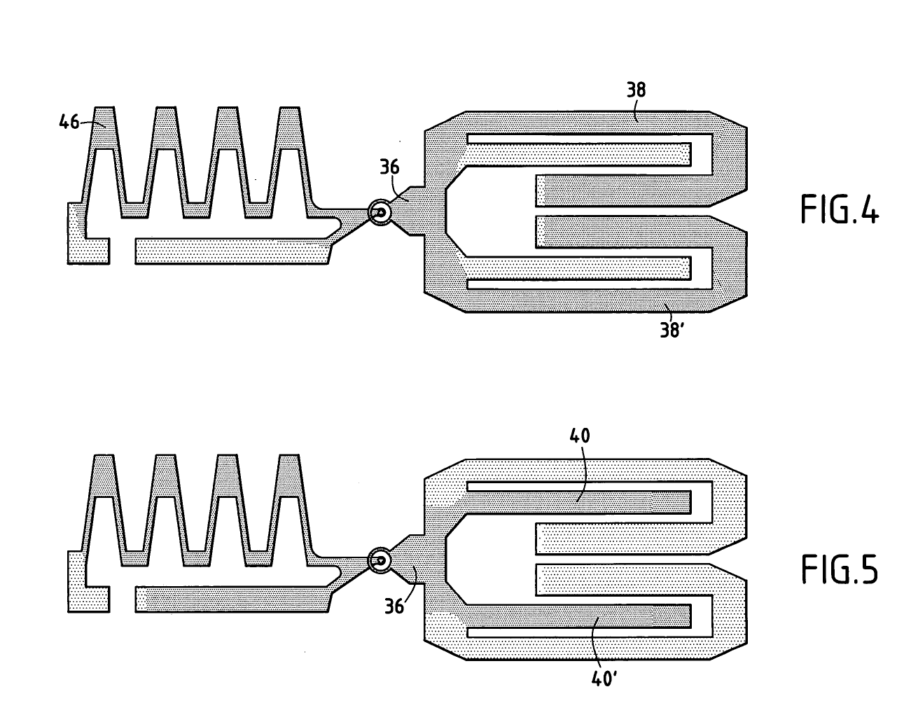

The operating principle of the compact antenna is described below with reference to FIGS. 4, 5, and 6.

For a frequency substantially equal to the 900 MHz center frequency of GSM, i.e. close to the lowest cellular frequency, the radiating portion of length substantially equal to one-fourth of the wavelength enters into resonance. In other words, it is the zigzag-forming portion 22 of the first branch 16 of the radiating element 12 that resonates. Current distribution 46 is thus particularly localized in the zigzag-forming portion and in the connection zone 20.

Electrical balance implies in conventional manner a current distribution on the ground plane 14 counterbalancing the current distributions 46 on the radiating element 12.

In the present invention, the counterpoise 14 acts as a compact ground plane.

In other words, current distribution on the counterpoise is preferably localized on the U-shaped portions 38, 38′ as shown diagrammatically in FIG. 4, while the rectangular portions 40 carry practically no current.

For the center frequency which is substantially equal to the 1900 MHz PCS frequency, i.e. close to the highest cellular frequency, the radiating portion of length substantially equal to one-fourth of the wavelength of said wave enters into resonance. I.e. it is the rectangular portion 26 that enters into resonance.

Because of the proximity of the two portions 26 and 16, a parasitic coupling phenomenon appears between these two portions such that the zigzag-forming portion 22 also enters into resonance.

Current distribution on the counterpoise is such that current is distributed over the portion of the counterpoise having length close to one-fourth the wavelength for the frequency band in question.

In other words, current distribution of the compact counterpoise 14 is particularly localized on the connection zone 36 and on the rectilinear portions 40 and 40′.

It will thus be understood that in spite of the absence of a theoretically ideal ground plane, i.e. a plane of very large size, the compact counterpoise 14 performs the function of two ground planes at the operating frequencies of the antenna.

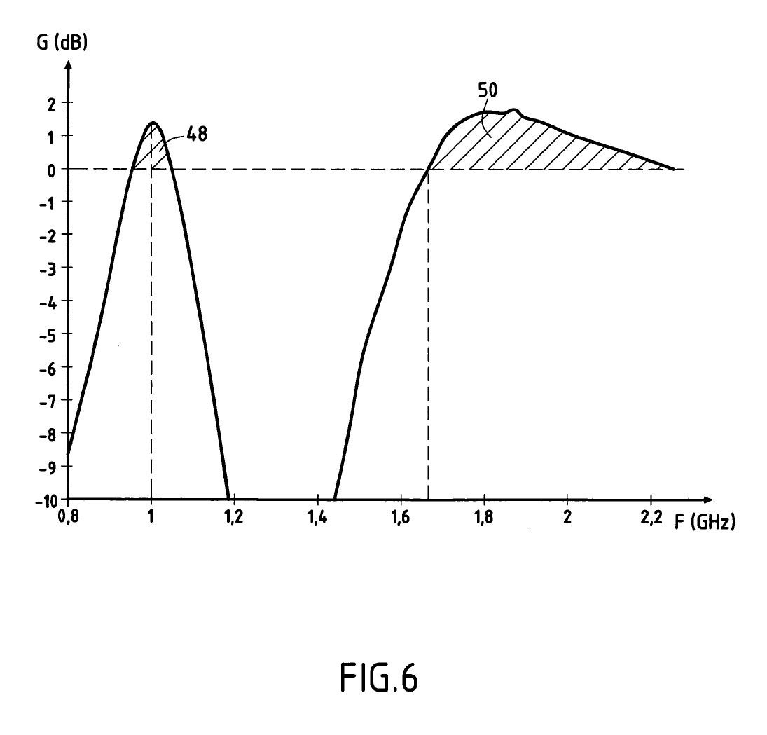

With reference to FIG. 6, there follows a description of the gain/frequency plot for the compact antenna 10 constituting the first embodiment.

In this plot, the abscissa axis represents the frequency applied to the feed line 32 of the antenna 10. This frequency is expressed in gigahertz and its spectrum varies over the range 0.8 GHz to 2.3 GHz.

The ordinate axis represents the gain of the compact antenna in dBi.

It can be seen that for a frequency close to 0.9 GHz, the gain of the antenna is high, lying in the range 0 to 1 dBi. This frequency band 48 close to 0.9 GHz corresponds substantially to the 850/900 MHz GSM band. The antenna is thus suitable for use in this frequency band.

In addition, it can be seen that the gain of the antenna is particularly high at frequencies lying in the range 1700 MHz to 2200 MHz. This frequency band 50 is relatively broad and corresponds to the DCS 1800, PCS 1900, and UMTS 2100 frequency bands. The antenna is thus suitable for use in these frequency bands.

The width of this frequency band is due in particular to the proximity of the rectangular portion 26 and the zigzag-forming portion 22.

As already explained above, a coupling and parasitic effect appears at frequencies close to 1900 MHz, thereby broadening the passband of the antenna and this frequency, and thus enabling the antenna to be used as higher frequencies, in particular at UMTS 2100 frequencies.

It can thus be understood that the compact antenna of the present invention is suitable for use both in the GSM frequency band in the UMTS frequency band.

FIG. 2 shows a second embodiment of the compact antenna 100 in which the radiating element 120 is identical to that of the first embodiment of the compact antenna, and in which the counterpoise is identical, except insofar as it does not include rectilinear portions as in the first embodiment.

Elements identical to those of the first embodiment are given the same references multiplied by one hundred.

As can be seen in FIG. 2, the limbs 440 and 440′ are placed close to each other and also close to the limbs 420 in order to encourage coupling and parasitic phenomena.

1. A monopole type antenna suitable for operating in cellular frequency bands, and comprising:
a conductive surface forming a radiating element and including an electrical connection zone, said radiating element being in the form of an open loop having two branches both connected to the antenna cable and defining first and second radiating portions, each of said radiating portions being suitable for entering into resonance at at least one cellular frequency and extends in a main direction; said two main directions being substantially parallel so as to operate parasitically and with coupling between the two radiating portions;
a compact conductive counterpoise including a connection zone; and
a feed line comprising an antenna cable connected to said connection zones of said radiating element and of said compact counterpoise.

2. An antenna according to claim 1, wherein the first radiating portion is a substantially plane conductive surface part of which is constituted by a juxtaposition of identical patterns extending in a direction substantially orthogonal to the main direction of the first radiating portion.

3. An antenna according to claim 2, wherein said pattern is substantially V-shaped.

4. An antenna according to claim 2, wherein said first radiating portion has at least four identical patterns.

5. An antenna according to claim 1, wherein the folded-out length of the first radiating portion is substantially proportional to one-fourth of the wavelength of the wave having a center frequency substantially equal to the lowest cellular frequency.

6. An antenna according to claim 3, wherein the folded-out length of the first radiating portion is substantially proportional to one-fourth of the wavelength of the wave having a center frequency substantially equal to the lowest cellular frequency.

7. An antenna according to claim 1, wherein the second radiating portion is a substantially rectilinear conductor extending in the main direction of said second radiating portion.

8. An antenna according to claim 3, wherein the second radiating portion is a substantially rectilinear conductor extending in the main direction of said second radiating portion.

9. An antenna according to claim 1, wherein the length of the second radiating portion is substantially proportional to one-fourth of the wavelength of the wave having a center frequency substantially equal to the highest cellular frequency.

10. An antenna according to claim 7, wherein the length of the second radiating portion is substantially proportional to one-fourth of the wavelength of the wave having a center frequency substantially equal to the highest cellular frequency.

11. An antenna according to claim 1, wherein the compact counterpoise has an axis of symmetry parallel to the main direction of the first radiating portion and wherein the antenna includes at least one U-shaped portion comprising first and second limbs, with the first limb being connected to the connection zone of said compact counterpoise.

12. An antenna according to claim 11, wherein the U-shaped conductive portion has two rectilinear limbs each extending in a direction substantially parallel to the axis of symmetry of the compact counterpoise.

13. An antenna according to claim 11, wherein the compact counterpoise has two U-shaped portions in which the second limbs are placed facing each other.

14. An antenna according to claim 11, wherein the compact counterpoise includes at least one conductive rectilinear portion extending in a direction parallel to the axis of symmetry of the compact counterpoise, and wherein an end of said at least one rectilinear portion is connected to the connection zone of the compact counterpoise.

15. An antenna according to claim 14, wherein said rectilinear portion extends substantially between said two limbs of a U-shaped portion.

16. An antenna according to claim 11, wherein the lengths of the limbs of a U-shaped portion and of a rectilinear portion are substantially equal.
